(19) United States
(12) Patent Application Publication
(10) Pub. No.: US 2016/0021683 A1
(43) Pub. Date: Jan. 21, 2016

(54) SYSTEM AND METHOD FOR PERSONAL COMMUNICATIONS AND PROTECTION USING INTELLIGENT ELECTRONICS

(71) Applicant: Cuff, Inc., San Francisco, CA (US)

(72) Inventors: Deepa Vora Sood, San Francisco, CA (US); Bradley Leong, San Francisco, CA (US)

(21) Appl. No.: 14/814,299

(22) Filed: Jul. 30, 2015

Related U.S. Application Data
(63) Continuation-in-part of application No. 14/611,928, filed on Feb. 2, 2015.
(60) Provisional application No. 61/934,690, filed on Jan. 31, 2014.

(51) Int. Cl. H04W 76/00; H04M 1/21; H04W 4/22

(52) U.S. Cl. CPC H04W 76/007; H04W 4/22; H04M 1/21

(57) ABSTRACT

A system and method for connecting and protecting people using a combination of (a) a “Private Personal Network” including a set of people who are defined as an individual's closest connections; (b) software that runs on mobile devices that manages, among other things, the members of the Private Personal Network, an individual's information, the connections to the Intelligent Electronics, and the connections to a cloud-based system; (c) a cloud based system that maintains connections among individuals, geographic data, and other data transmitted from the software on the mobile device, from the Intelligent Electronics, and from other sources; and (d) technology that receives and sends communication to the mobile device and is integrated with custom-designed wearable product.

### CROSS-REFERENCE

This application is a continuation-in-part application of Ser. No. 14/611,928, filed Feb. 2, 2015, to which application we claim priority under 35 USC §120, and which claims the priority of U.S. Provisional Application Ser. No. 61/934,690, dated Jan. 31, 2014 which are incorporated herein by reference in their entirety.

### BACKGROUND OF THE INVENTION

The invention pertains generally to communication devices and, more specifically, to communication via an interchangeable electronic device that uses wireless protocols.

Existing communication devices, which are incorporated into wearable products, do not meet the demands and needs of the current consumer. For example, wearable products incorporate electronic components and sensors into plastic or molded bracelets and other such devices, which can be attached to the body through various mechanisms. However, most of these devices are not integrated into high end wearable products. Known approaches are segmented into three areas: wearable BLE devices, personal protective systems, and customizable jewelry.

With respect to wearable BLE devices, there are numerous devices (such as FitBit, Shine, and Fuel) that provide electronics integrated with molded plastic or metal. There are many disadvantages to these devices. For example, some of these devices require recharging on a regular basis, which may result in the device being unavailable when most needed. Furthermore, the decision to use molded plastic or metal means the aesthetics are appropriate primarily in sports situations and are not suitable to many social, work, or evening situations, severely limiting the utility of the device. Additionally, if the device is rechargeable, then it is both bulky and typically not waterproof, further limiting their usability by a wide range of physical body types and situations.

With respect to personal protective systems, there are numerous devices provided by LifeAlert (tethered to home) and Life360 (phone based only). Similarly these devices suffer from the same limitations.

With respect to devices that are part of customizable jewelry, there are similar limitations to using these products by fashion designers. For example, vendors such as Gucci or others only offer watches that have interchangeable rings providing color customization. These items serve no useful function and lack the intelligence needed to communicate information; they are only decorative.

In view of the foregoing disadvantages inherent in all the above types of products, all of which address part of a solution, but not the entirety of the needs of current consumers, an enhanced apparatus or device is needed along with a system that supports the data management. Therefore, what is needed is a system and method for integrating an electronic device into wearable products, such as jewelry, clothing, and handbags, to allow for communication and providing services to a consumer while maintaining a level of fashionable quality that is applicable under numerous settings.

### SUMMARY OF THE INVENTION

The present disclosure is directed at a system and method for integrating an electronic device into wearable products, such as jewelry, clothing, and handbags, to create intelligent products that provide many advantages. The disclosed aspects of the invention, as set out in the various embodiments, allow for communication to/from the device-from/to another device-while maintaining a level of fashionable quality that is applicable under numerous settings.

The various aspects of this disclosure can be implemented in any manner and the scope of the invention is not limited to specific embodiments disclosed. The device is able to communicate with a mobile device or directly to other intelligent jewelry. For example, the device can be integrated or secured to personal items such as jewelry to create intelligent jewelry. The intelligent jewelry serving either as originators of communications via a button-press, or receivers of information through the use of a coin vibrator or other alerting device that is an integrated component of the electronic device. The intelligent jewelry connects to and communicates through a mobile device or alternatively a “BLE concentrator” which serves as an intermediary communication and transmission hub, said intelligent jewelry additionally communicating via these means with a cloud application that manages people, connections, and locations.

In accordance with at least one aspect and embodiment disclosed herein, a system is disclosed that includes electronics that can be interchangeably embedded in jewelry. The jewelry can come in a variety of materials including leather, horn, metal, plastic, molded plastic, or other materials, referred to as an intelligent wearable product (IWP). The IWP is available in a variety of form factors, including but not limited to, bracelets, pendants, lavolieres, necklaces, cuff-links, earrings, ankle bracelets, key chains, belts, money clips, and other such jewelry items. The IWP, meant to be worn by people, communicates via software on a mobile device or other long-distance transmission device to a cloud system which facilitates communications and data management.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a flow process for communication with an intelligent wearable product (IWP), such as a registered device, in accordance with the various aspects of the invention.

FIG. 2 shows a flow process for communication between the IWP and a mobile device in accordance with the various aspects of the invention.

FIG. 3 is a block diagram of the registered device and various communication channels in accordance with the various aspects of the invention.

FIG. 4A is a top view of an IWP, as shown in FIG. 3 in accordance with the various aspects of the invention.

FIG. 4B is a perspective view of an IWP, as shown in FIG. 3 in accordance with the various aspects of the invention.

FIG. 4C shows an IWP in accordance with the various aspects of the invention.

FIG. 4D shows an IWP in accordance with the various aspects of the invention.

FIG. 4E shows an IWP in accordance with the various aspects of the invention.

FIG. 4F shows an IWP in accordance with the various aspects of the invention.

FIG. 5 shows a system that includes the IWP in accordance with the various aspects of the invention.

FIG. 6 shows various housings for the IWP in accordance with the various aspects of the invention.

FIG. 7 shows various implementations of the IWP in accordance with the various aspects of the invention.

FIG. 8 shows an example of an IWP having a registered device accessible from a side facing a user in accordance with the various aspects of the invention.

### DETAILED DESCRIPTION OF THE INVENTION

In accordance with the various aspects of the invention, the computing devices of the invention may include a central processing unit, memory, input devices (e.g., keyboard and pointing devices), output devices (e.g., display devices), and storage devices (e.g., disk drives). The memory and storage devices are computer-readable media that may contain instructions. In addition, the data structures and message structures may be stored or transmitted via a data transmission medium, such as a signal on a communications link. Various communications links may be used, such as the Internet, a local area network, a wide area network, or a point-to-point dial-up connection.

The systems of the invention, in accordance with various aspects and embodiments, may use various computing systems or devices including personal computers, server computers, hand held or laptop devices, multiprocessor systems, microprocessor based systems, programmable consumer electronics, network PCs, minicomputers, mainframe computers, distributed computing environments that include any of the above systems or devices, and the like. The systems may also provide services to various computing systems such as personal computers, cell phones, personal digital assistants, consumer electronics, home automation devices, and so on.

The systems may be described in the general context of computer-executable instructions, such as program modules, executed by one or more computers or other devices. Generally, program modules include routines, programs, objects, components, data structures, and so on that perform particular tasks or implement particular abstract data types. One or more memory storage units may comprise non-transitory computer readable media that may include code, logic, or instructions for performing one or more steps as described herein. Typically, the functionality of the program modules may be combined or distributed as desired in various embodiments. For example, the user interface component may be implemented on a server separate from the computer system that generates the information or data.

Unless defined otherwise, all technical and scientific terms used herein have the same meaning as commonly understood by one of ordinary skill in the art to which this invention belongs. Although any methods and materials similar or equivalent to those described herein can also be used in the invention, representative illustrative methods and materials are now described.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In accordance with at least one aspect of the invention, high-end jewelry design may be coupled with technology in a manner that is aesthetically appealing, providing tremendous flexibility to create intelligent wearable products (IWPs). IWPs may have any form factor, such as bracelets, bangles, necklaces (e.g. pendants), anklets, rings, earrings, keychains, headbands, belts, and other jewelry and jewelry-like items. These designs incorporate powerful electronic capability within jewelry, which would be appropriate for sale in a jewelry store.

One object, in accordance with at least one aspect of the invention, is to provide a protection and communication system with interchangeable and customizable components that will overcome the shortcomings of known approaches.

Another object, in accordance with at least one aspect of the invention, is to provide a waterproof sealed electronic component including a board, a power source (such as a battery or a solar cell), a button, and a vibrator, which can be embedded in various forms of jewelry.

Another objective, in accordance with at least one aspect of the invention, is to enable the easy interchange of the sealed component among different types of jewelry, for example between a bracelet, a necklace, or a keychain. This is done through a variety of interchangeable connectors.

Another objective, in accordance with at least one aspect of the invention, is to enable the combination of jewelry and electronics (called IWP) to seamlessly integrate and provide the appearance of jewelry alone.

Another objective, in accordance with at least one aspect of the invention, is to enable the combination of jewelry and electronics to communicate with a mobile device, or directly with a network, using one or more communication protocols integrated into the IWP, including Bluetooth Low Energy (BLE).

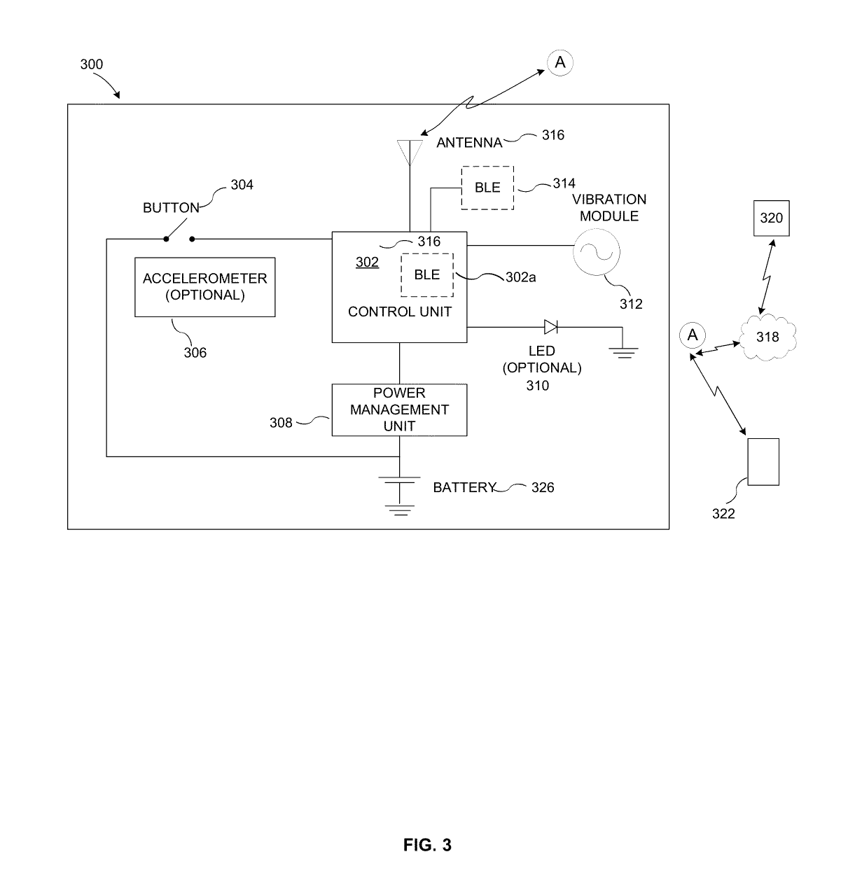

Another objective, in accordance with at least one aspect of the invention, is for the IWP to operate in multiple modes: either sending or receiving. In sending mode, one or more presses of a button (shown in FIG. 3) are transmitted to the mobile device or network. In receiving mode, these presses are translated to vibrations, each different from the other, on the IWPs or one or more recipients, or the recipient's mobile device.

Another objective, in accordance with at least one aspect of the invention, is for the IWP to be customizable via a set of interchangeable inserts that provide decorative customization.

Another objective, in accordance with at least one aspect of the invention, is to have software that resides on the mobile device, which receives messages from the IWP and transmits them to a cloud-based system. The software can also display personal information such as contact information and medical/insurance information, show geographic locations of various individuals, and provide alerting and SOS functions.

Another objective, in accordance with at least one aspect of the invention, is to have cloud based software which manages all of the data related to the individuals registered in the network, track the individual via their IWPs, manage the communications between members of the Personal Network, maintain data integrity, and continue to transmit alerts even if the mobile device has been turned off or the IWP is not in standby-status with the mobile device.

Another objective, in accordance with at least one aspect of the invention, is to have a “Personal Social Network” of individuals who have been identified as those most important to communicate with, arranged in one or more groups that have attributes describing their familial as well as geographic proximity to certain individuals.

Another objective, in accordance with at least one aspect of the invention, is to have the electronic unit not require recharging, to be waterproof, and to be able to vibrate sufficiently as to be felt even when encased in a housing or jewelry.

Another objective, in accordance with at least one aspect of the invention, is to enable people to immediately alert individuals without having to touch their mobile device.

Another objective, in accordance with at least one aspect of the invention, is to be able to have a complete range of jewelry, such as bracelets, necklaces, etc., among which the electronic component can be integrated.

Referring now to FIG. 3, in accordance with the various aspects of the invention, an IWP is a device, which may include a registered device 300 as shown. The registered device may optionally be modular. The registered device 300 may include a control unit 302 and a battery 326. Any reference to a battery may refer to any type of power supply unit or energy savings device. The battery may be any type of battery, such as a lithium-ion battery. In accordance with one aspect of the invention, the control unit 302 may include a circuit board with BLE technology, such as a BLE module 302a. In accordance with another aspect of the invention, a BLE module 314 is a separate module from the control unit 302. Any description herein of BLE or a BLE module may apply to any type of communications unit. The communications unit may be a direct communication unit that may be capable of directly connecting with another device. This may include Bluetooth, infrared, Zigbee, near field communication, ultraband, WiFi, or optical communications. Any type of short-range wireless communications may be provided (e.g., on the order of reaching at least a few centimeters, tens of centimeters, meters, or tens of meters).

The registered device 300 may include any one or more of the following, in communication with the control unit 302: a button or depressible unit 304, an accelerometer 306, a power management unit 308, a Light Emitting Diode (LED) 310, a vibration module or unit 312.

Any description herein of a button or depressible unit may be applied to any type of input device that may accept a user input. In some instances, the input device may be configured to recognize a tactile input from a user. The input device may recognize mechanical deformation or movement of a component as an input from the user. For instance, a flexible membrane may be deformed by a user's touch. In some instances, a rigid film or plate may be displaced by the user's touch to register an input from the user. Other signals from a user (e.g., thermal signals, capacitive signals, acoustic signals, motion signals, auditory signals, or optical signals) may or may not be recognized as an input from a user via the user input device. The input device may or may not include a touchscreen. In some instances, the input from the user must exceed a threshold value to be detected as a tap or input. For instance, a degree of deformity by a flexible membrane, button, depressible unit, may need to exceed a threshold deformity and/or duration to be detected as an input. Similarly, a degree of pressure asserted by the user on the input device may need to exceed a threshold pressure value. In some instances, an amount of time that the user is pressing the flexible membrane may need to exceed a threshold time value. The input device may or may not provide tactile feedback to the user that the user has successfully pressed the device (e.g., that a user touch has been registered).

In some embodiments, the input device may take an entire surface of the registered device. For instance, the input device may cover a whole side of the registered device so that if the user touches any portion of the side, it may be registered as an input. In some instances, the input device may cover a majority of the side of the registered device (e.g., area greater than or equal to about 50%, 60%, 70%, 80%, 90%, 95%, or 99% of the area of a side of the input device). This may allow the user to easily tap the input device without looking The user can tell by just feeling whether the user has touched the input device.

In some embodiments, the input device may recognize binary signals (e.g., the user is touching the input device or is not touching the input device). In some instances, the user signal may be analyzed over time and may permit the user to provide multiple types of input (e.g., depending on the length of the input, a number of touches by the user, or a temporal sequence of touches from the user). For instance, a single short touch by the user may have a different meaning than a single long touch by the user. Length of touch may be discernible on the order of seconds, tenths of seconds, hundredths of seconds, or thousandths of seconds. In another example, a single touch versus two touches spaced closed to one another in time may have different meanings Optionally, user touches may be interpreted in a similar manner as Morse code. The location of a user's touch on an input device may or may not make a difference in interpretation of the user's input. In some instances, any touch on an input device, regardless of location on the input device, may be interpreted in the same manner. Alternatively, touches in different locations of the input device may be interpreted differently.

Any description herein of an accelerometer may apply to any type of inertial sensor. This may include one or more accelerometers measuring acceleration in one, two, or three spatial directions, one or more gyroscopes measuring rotation about one, two or three axes, or one or more magnetometers. The device may optionally be capable of detecting spatial translation and/or adjustment in orientation of the device. An inertial sensor may measure linear position, angular position, linear velocity, angular velocity, linear acceleration, and/or angular acceleration of the device. Movement of the registered device may be stored as passive data collected by the registered device. Alternatively or additionally, the movement of the registered device may be recognized as active user input. For instance, the user may violently shake the IWP to send a message.

The power management unit 308 may regulate different voltage requirements in the device, can control charging in devices with rechargeable batteries, and/or may control the flow of power throughout the device.

Any description of an LED may apply to any other type of visual indicator on the device. This may include any type of light source (e.g., various types of electroluminescent lights, lasers, gas-discharge lights). The visual indicator may be a binary visual indicator (e.g., turning on or off) or may have other features (e.g., different colors, blinking patterns, visual patterns). The visual indicator may be used to provide an alert to a user of the registered device. Information from a visual indicator may be interpretable by the user.

A vibration module or unit may be provided on the registered device. Any type of tactile feedback may be provided to a user by the registered device. In some embodiments, the tactile feedback may be provided as binary signals (e.g., a vibration is occurring or is not occurring). In some instances, the vibration may have a pattern that occurs over time and may permit the user to interpret different types of vibration patterns (e.g., depending on the length of the vibration, degree of vibration, a number of pulses or vibrations occurring, or a temporal sequence of vibrations). For instance, a single short pulse may have a different meaning than a long vibration. In another example, a single pulse versus two pulses spaced closed to one another in time may have different meanings. Optionally, vibrations may be interpreted in a similar manner as Morse code. The entire registered device may shake as a result of the vibration module. The shaking or vibration of the registered device may be detectable by an individual wearing the IWP.

In alternative embodiments, a speaker or other auditory output device may be provided. An audible output device may interpretable by the user. The audible output may include a beep, a tone, a song, words, or any other type of sound. In some instances, one or more, two or more, or three or more of a visual indicator, tactile indicator, or audible indicator may be provided on a registered device to convey information to a user.

The registered device 300 also includes an antenna 316 in electrical communication with the control unit 302. The registered device 300 communicates with other devices, systems or computers using a communication protocol.

In accordance with at least one aspect of the invention, the registered device 300 uses the antenna 316 for communication using BLE protocol. In accordance with at least one other aspect of the invention, the registered device 300 can use any one or combination of communication units and protocol, independently or conjunction with BLE, including optical, Infrared (IR), laser optics, WiFi. Thus, the scope of the present disclosure is not limited by the type of communication protocol used and any known communication approach, including combinations thereof, may be utilized.

In accordance with at least one aspect of the invention, the registered device 300 may communicate with an external device 322. The external device may be a mobile device such as a smartphone, cellular phone, tablet, personal digital assistant (PDA), or pager. The external device may be a computer, such as a laptop or desktop computer. The external device may be capable of receiving direct communications from the registered device, e.g., through the antenna. The external device may or may not be capable of further communications with other devices, such as over a network. The external device may or may not communicate with a server, host system, or back-end data management system. The external device, such as the mobile device, may have a software or application. The registered device may communicate with the software or application of the external device. In accordance with another aspect, the registered device 300 communicates through intermediate transmitter, such as through a network 318, to a server, a host system, or a back-end data management service 320. The network may be a local area network (LAN), wide area network (WAN) such as the Internet, a telecommunications network (e.g., 3G, 4G, LTE), or any other type of network. In some embodiments, the server, host system, or back-end data management service may be a type of external device. By communicating over a network, the registered device may be communicating indirectly with the server, host system, or back-end data management service.

In accordance with at least one aspect of the invention, the registered device 300 can transmit information to a Personal Private Network (PPN) or Trusted Circle of device or people (TCD) equipped with either a mobile device or a mobile device in conjunction with a IWP, such as registered device 300. In accordance with the various aspects of this disclosure and the invention, the PPN or TCD may include any individual based on geographic location, relationship to the user of the registered device, or any other criteria selected by the user of the registered device 300 or the IWP. The registered device 300 can communicate with the TCD through various channels of communication as outlined herein and the scope of the present disclosure is not limited by the channel selected.

The registered device may communicate with an external device by transmitting data to the external device. The registered device may send data to the external device directly or indirectly. In some instances, a user input to an input device of the registered device may be interpreted at the registered device, and data pertaining to the interpretation of the user input may be transmitted to the external device. In alternative embodiments, the interpretation may occur at an external device, and data pertaining to the user input may be directly transmitted to the external device.

The registered device may or may not receive data from an external device. In some instances, the registered device may receive notification from an external device. The registered device may be used to alert a user wearing or carrying the registered device. The received information may cause a visual, tactile, and/or audible alert to be provided. Different types of alerts may be interpreted based on different alert media or patterns.

The registered device may be capable of two-way communication. The registered device may both transmit data and receive data. The registered device may transmit data based on data passively collected by the registered device. Some examples of passive data that may be collected by the device may include, but are not limited to, geographic location of the device, movement of the device, biometrics of a wearer of the device, environmental data collected by the device (e.g., temperature, pressure). Alternatively, the registered device may transmit data based on one or more active user input to the device. Some examples of user input may include, but are not limited to, a tap or click of the registered device by the user, a verbal command spoken by the user, shaking or other specified motion of the device. In some instances, the registered device may transmit data including both data passively collected by the registered device and data actively input by the user. The registered device may alternatively only send information passively collected by the registered device without data actively input by the user, or the registered device only send information based on an active input by the user without sending information passively collected by the device. For instance, the user may touch a tactile input device. The registered device may receive information that may be used to alert a user associated with the device. A user of a device may both convey and receive information.

In accordance with at least one aspect of the invention, the registered device 300 can be incorporated into jewelry to create customizable intelligent jewelry. The registered device may be incorporated as part of an IWP. The IWP may have any form factor as previously described. The IWP may be formed from a material that may be reflective of high-end jewelry design. For instance, the IWP may include precious metals (e.g., gold, silver, platinum) or any other type of metal or alloy (e.g., titanium, palladium, rhodium, tungsten carbide, stainless steel, brass, copper). The IWP may include precious stones, semi-precious stones, or other decorative features (e.g., diamonds, sapphires, rubies, emeralds, opals, onyx, topaz, amber, amethyst, jade, pearls, zircon, crystal, or glass). The IWP may include chains, links, bands, loops, mesh, straps, solid support, or any other components.

The registered device may have a modular form that may be attachable and detachable to the rest of the IWP. The registered device may be capable of operating independently of the rest of the IWP. For instance, the registered device may send and/or receive information even when not attached to the IWP. The registered device may be capable of receiving and/or interpreting a user input even when not attached to the IWP. The IWP may provide a support for the registered device. The IWP may or may not include any electronic components or communication components. The IWP may allow the user to wear and/or carry the registered device in an inconspicuous manner. The registered device may or may not be readily visible when the IWP is worn or carried by the user. When viewable, the registered device may or may not be discernible from the rest of the IWP (e.g., jewelry substrate component). The registered device may or may not be visually apparent as a device housing electronic members. The registered device may appear to be formed from a material commonly used in jewelry, such as any of the materials described above. In alternate embodiments, the registered device may require the rest of the IWP to operate. The IWP may have one or more components that may permit the modular registered device to send and/or receive information.

An IWP may be connected and disconnected from a modular registered device in any manner. For instance, the registered device may snap-fit with the rest of the IWP. The registered device may be snapped out of the IWP. In some instances, the IWP or the registered device may have a conformable portion that may be configured to accept a corresponding rigid portion or conformable portion. For example, the IWP may include a conformable portion or interface that may accept a hard registered device, or vice versa. The attachment and/or detachment may occur with aid of one or fasteners, hook-and-loop interfaces, magnets, slide-lock features, twisting interfaces, clasps, or any other mechanisms. The registered device may fit into an indentation or cavity of the IWP.

The registered device may be attached and/or detached from the rest of the IWP. In some instances, the registered device may be transferred between different IWPs. The different IWPs may have the same or different form factors. For instance, the modular registered device may be attached to a first IWP having a first form factor (e.g., a bracelet). The registered device may then be removed from the first IWP and attached to a second IWP having a second form factor (e.g., a pendant). Thus, the registered IWP may be transferred between different IWPs, which may allow a wearer to have multiple looks, but re-use the same intelligent component.

Similarly, an IWP may have different registered devices that may be swapped in and out. The different registered devices that are swapped in and out from the IWP may have the same form factor or may have different form factors. The different registered devices may have the same appearance or may have different appearances. For instance, the different registered devices may have the same color or different colors. Different registered devices may have the same surface finish or different surface finishes.

The different registered devices may have the same functionality or may have different functionalities. The different functionalities may relate to outgoing communications, incoming communications, or both. For instance, the different functionalities may include a different set of contacts for each modular device. For examples, different members of a user's TCD/PPN may be established for different modular devices. The different functionalities may also include different types of information that may be communicated by a user and/or received by the user (e.g., a first might be a health/safety set of communications, a second may be a social set of communications, a third may be work communications). The different functionalities may relate to user input (e.g., different types of user inputs, or different patterns of user input may relate to outgoing communications or types of outgoing communications). For instance, for a first registered device, a single tap may refer to a major emergency and a double tap may refer to a minor emergency, while for a second registered device, a violent shaking of the device may relate to a minor emergency and a double tap may refer to a major emergency. The different functionalities may relate to detectable responses from the registered device (e.g., for incoming messages). For instance, for a first registered device, a single pulse may mean a minor emergency and a double pulse may refer to a major emergency of another individual. For a second registered device, a flashing light may mean a minor emergency and an audible signal may refer to a major emergency. Any reference to different functionalities may apply to different sets of specifications for the different registered devices.

For instance, a first registered device may be attached to an IWP. The first registered device may be removed from the IWP and a second registered device may be attached to the IWP.

Any combination of modular registered devices may be swapped in and out of any type of IWP. This may provide a user with a great deal of flexibility in function, as well as appearance or adornment. A user may be able to simultaneously wear multiple IWPs, which may include registered devices of various functionalities. For instance, a bracelet may be provided that may be used for health/safety communications, and a necklace may be provided that may be used for social communications.

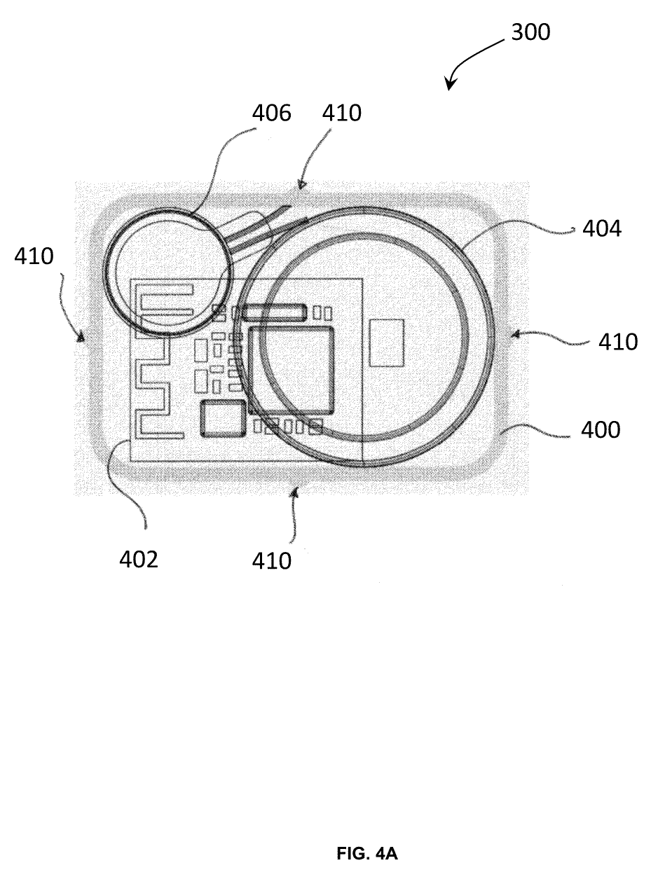

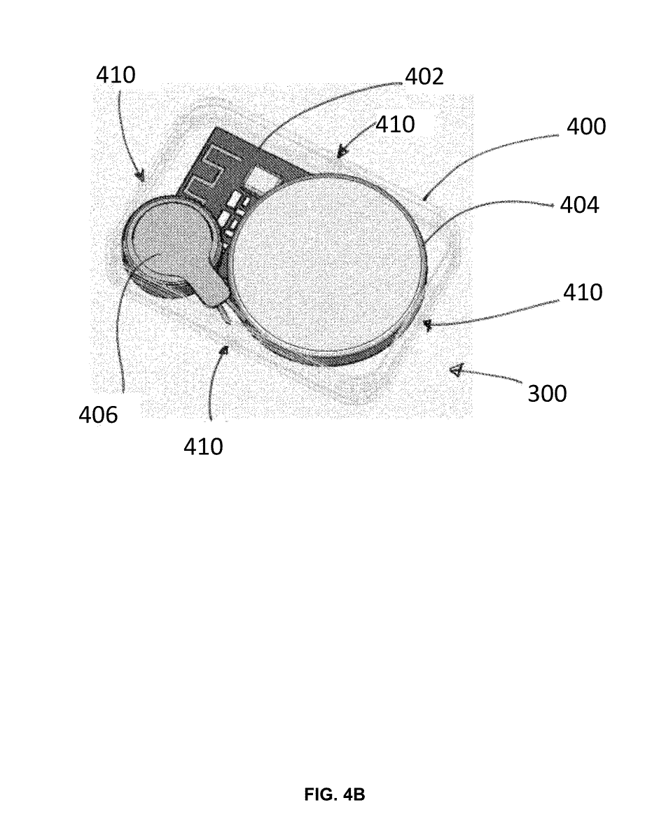

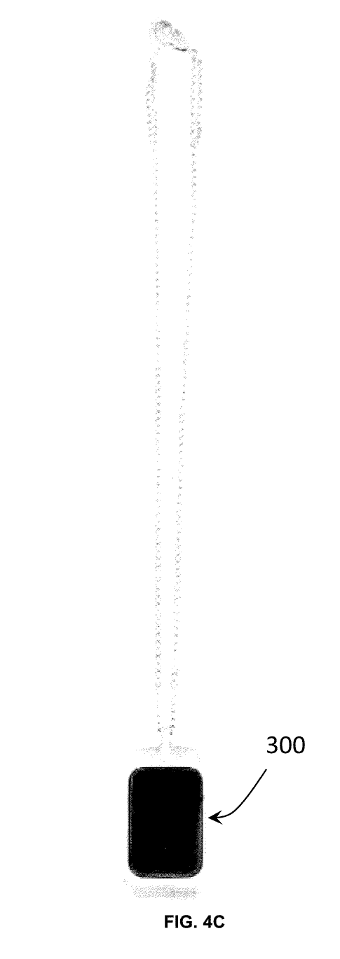

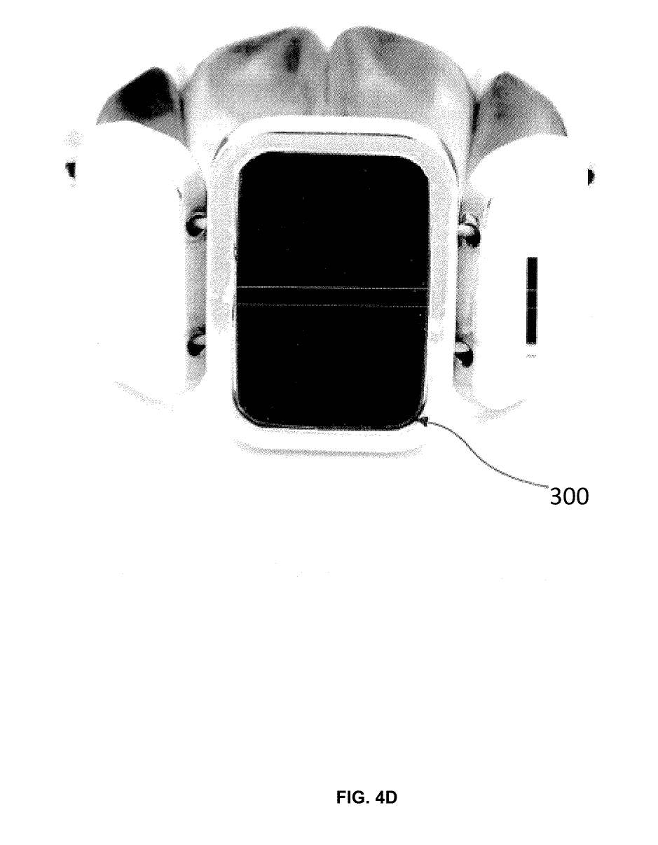

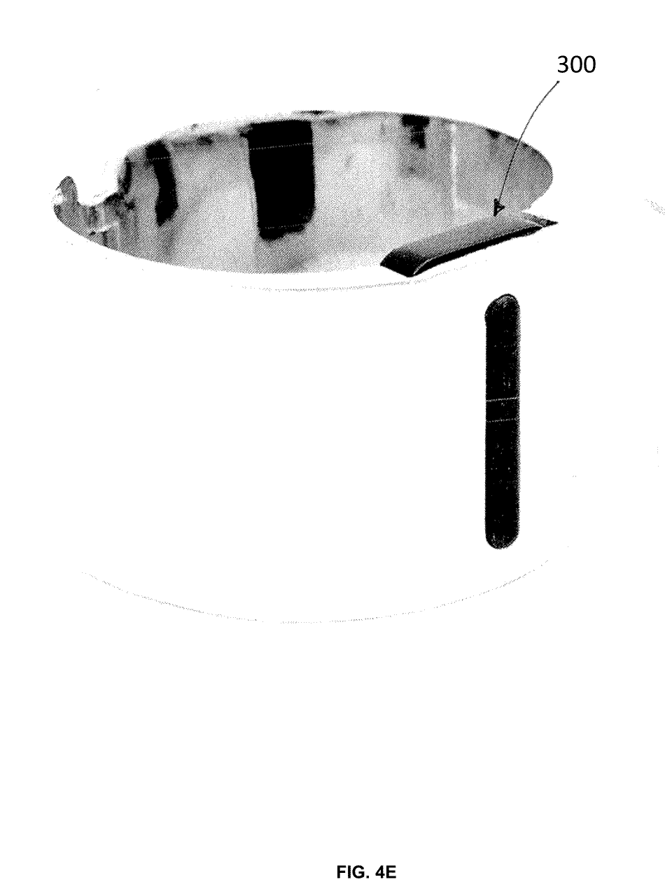

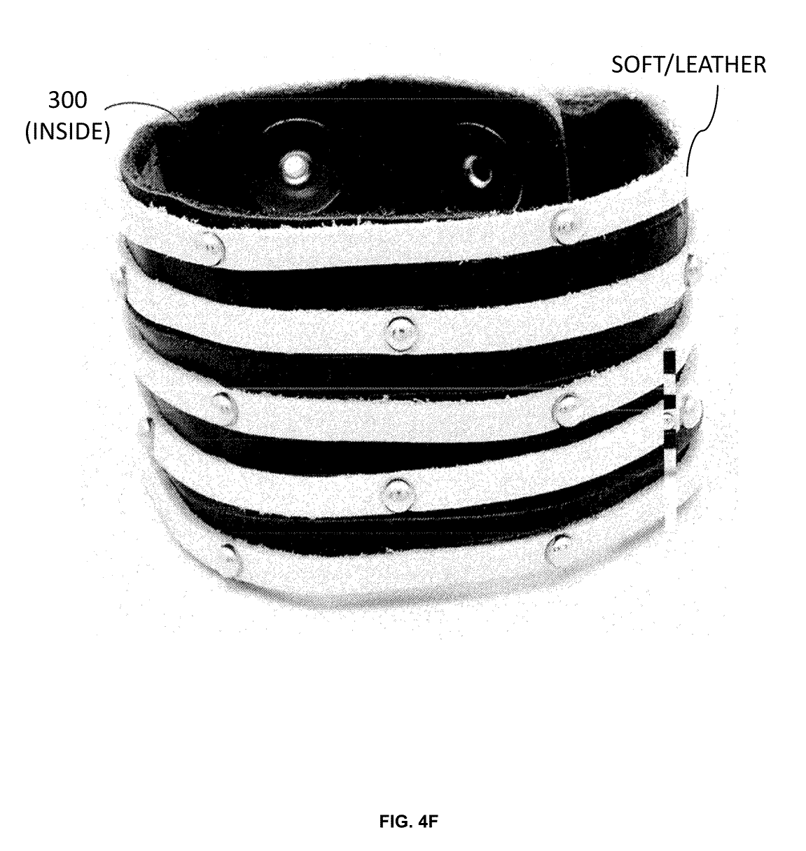

Referring to FIG. 3, FIG. 4A, and FIG. 4B, in accordance with various aspects of the invention, the IWP, such as the registered device 300, may include a waterproof enclosure 400 for housing electronic components 402, a battery 404, and a button 406 based on various design parameters. The registered device is coupled to the jewelry. In accordance with various aspects of the invention, there are multiple ways of attaching the registered device to the jewelry. One approach is an external ring (which may come in a number of shapes—rectangular, circular, oval, and square) into which the registered device can be inserted and removed. Another approach may be to couple the registered device directly to jewelry. In accordance with at least one aspect of the invention, bubbles or extensions 410 are incorporated to hold, via a press fitting, the registered device into the jewelry. These various aspects are disclosed as examples and other objects and advantages of the invention will become obvious to person of ordinary skill and it is intended that these objects and advantages are within the scope of the invention and the examples recited specifically are not intended to limit the scope of the claims.

The external device 322 and the system 320 includes software or program code that allows the user to perform any one or more of the following: account setup and sign-in; Personal Private Network or Trusted Circle setup; IWP or registered device connection to a mobile device; IWP and mobile device pairing; data entry; data gathering—location, audio, personal, other; historical & real time; data receiving—push notifications, communications displays; and alerts.

In accordance with various aspects of the invention, the software residing at a remote location or in the cloud includes, but is not limited to, a database and database schema, administrative panels including for the database administrator, business logic, the ability to create personal information and connections between individuals, and security or emergency services.

In accordance with various aspects of the invention, the IWP is designed to connect to and protect an individual with their TCD. The IWP and the system in communication with the IWP include features that allow controlled and specific communication with specific individual. Information is provided by the user, such as familial or personal closeness, in addition to geographic location. In accordance with various aspects of the invention, the information provided, is factored in the decision on which set of individuals in the TCD to alert in case of emergency and in what order. Because it is a cloud-based system, unlike a traditional 911 call or other phone-based system, once the alert has been passed to the cloud system, the cloud system will continue attempting to contact individuals according to proprietary algorithms which determine who to contact.

In accordance with various aspects of the invention, various messages, which can include emergency as well as non-emergency, are provide to and from the IWP. In accordance with one aspect of the invention, the IWP transmits two basic messages: Minor emergency and Major emergency. The actions to be followed upon that transmission are determined by proprietary algorithms in software associated with the mobile device or the back-end system. In accordance with other aspects of the invention, when the mobile device receives such a message from the IWP, the software is activated and gathers additional information such as current and historical geographic location. The information gathered can be sent from the mobile device to the system through cellular communication channels, the internet, or via any other communication channel.

The messages may be generated and/or differentiated based on information provided by a user. For instance, a user may provide an input via an input device of the registered device. The input may be a touch input. The user may touch a surface of the registered device to provide an input. The length, timing, number, and/or pattern of touches may be used to generate and/or differentiate a message. Optionally, a level of pressure exerted by the user in the touch or a location of the touch on a registered device may be used to generate and/or differentiate a message. For example, a single tap may be used to indicate a minor emergency while a double tap may be used to indicate a major emergency, or vice versa. A level of the emergency and/or nature of the emergency (e.g., health-related, attacker, etc.) may be communicated by the user input, such as a touch.

In accordance with various aspects of the invention, the IWP may receive two basic messages: Minor emergency and Major emergency, transmitted by the mobile device, which receives these messages from the back-end system. The mobile device also receives these messages. Upon receipt of this message, the mobile device, through the software stored therein, guides the recipient through a set of potential actions, provides additional information, and undertakes various additional processing actions.

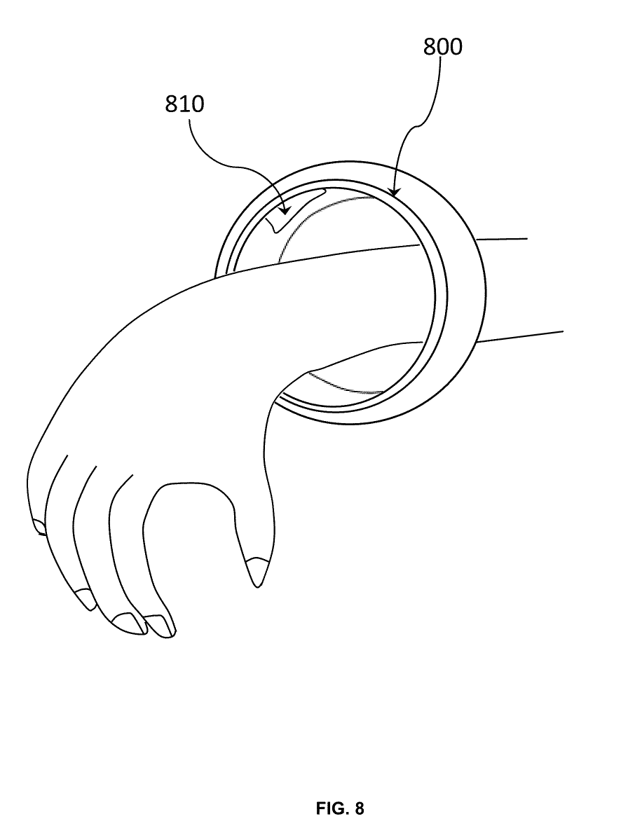

Using a simple input interface, such as a touch interface, may allow a user to easily and/or subtly communicate a message as needed. In accordance with an embodiment of the invention, as illustrated in FIG. 8, an IWP may have a registered device 810 supported by a jewelry substrate 800 and accessible from a side facing a user. As previously described, the registered device may be modular and may be removable and/or attachable to the jewelry substrate of the IWP. In some instances, the registered device may be attached and/or removed via a side of a jewelry substrate configured to face a user. For example, if the jewelry substrate is a bracelet, or other article that goes around a user's wrist or arm, the side facing the user may be the inner surface, which may be configured to face or contact the user's wrist or arm. If the jewelry substrate is a pendant, the side facing the user may be the back side of the pendant, configured to rest against the user's torso. If the jewelry substrate is a necklace, the side facing the user may be the underside of the necklace configured to touch or face the user's neck or chest. If the jewelry substrate is a belt, the side facing the user may be the inner surface of the belt. In some instances, if the registered device is on a side facing the user, a user's tap may be discernible to incidental contact with the user's skin, or the registered device may be configured to not easily come into contact with the user's skin. For example, the registered device may be slightly indented, or in a recess so that the registered device does not reach the same level as the surface of the jewelry substrate. The registered device may be recessed relative to the rest of the jewelry substrate.

Having a registered device on a side of the jewelry substrate facing the user may reduce the likelihood that the user accidentally provides an input to the registered device. For instance, if the user provides an input via tapping the registered device, the user may be less likely to accidentally tap the registered device when the registered device is not readily exposed. The user may have to make conscious effort to reach the side of the jewelry substrate facing the user. However, the user may still be able to readily access the registered device when needed. The tap of the registered device on a side facing the user may be subtle and may not alert passerby's that the user is sending the message, if the user does not wish.

For example, if the IWP has a bracelet form factor, a user may move the user's finger between the user's wrist and the registered device to tap the device.

The registered device may or may not be visible from an exterior surface of the jewelry substrate. The registered device may or may not be visible from a surface of the jewelry opposing the side facing the user. In some alternative embodiments, the registered device may be on a side opposing the side facing the user or any other side of the jewelry substrate.

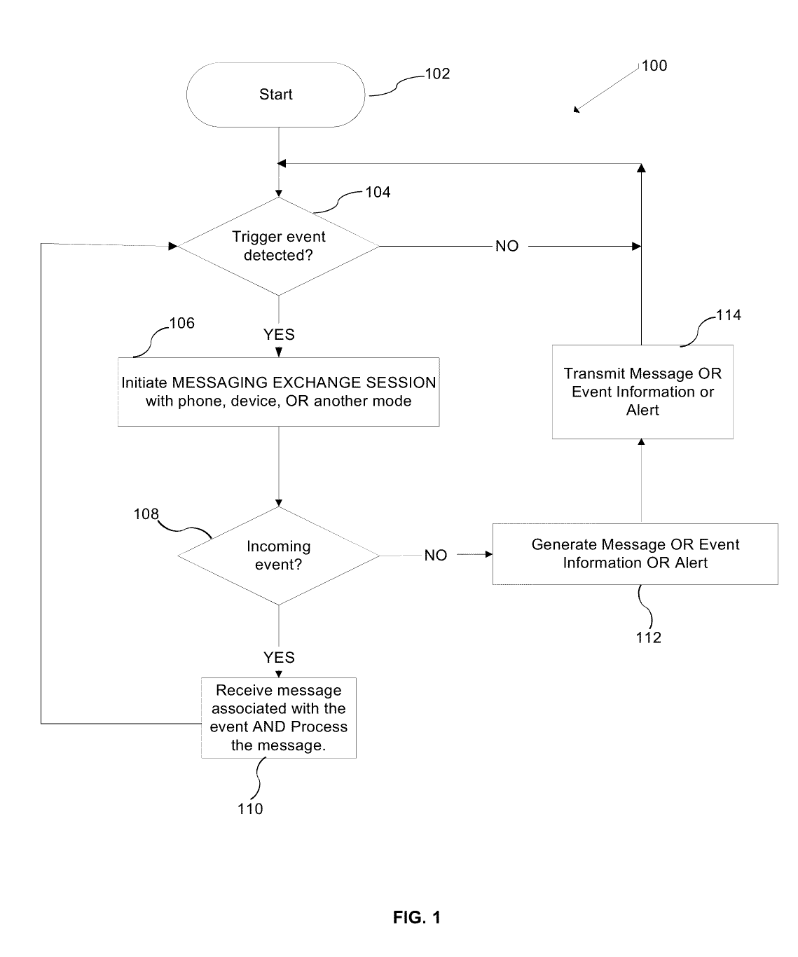

Referring now to FIG. 1, in accordance with various aspects of the invention, a flow process 100 is shown for communication to/from the IWP, such as the registered device 300 of FIG. 3. The process starts at step 102 and moves to step 104 to determine if a trigger event has been detected by the IWP. A trigger event is any event discussed herein, which causes the IWP to initiate communication. Examples of trigger events include pressing a button on the IWP, detection by the accelerometer of the IWP, or incoming communication from the mobile device. Trigger events may be initiated by a user wearing or carrying the IWP, or may be initiated from off-board the IWP, and may optionally come in through an external device, such as a mobile device. Thus, trigger events may be for outgoing messages or incoming messages. The examples listed are not exhaustive of all possible triggering events and the scope of the invention is not limited thereby. If a trigger event is NOT detected, the process returns to step 104 to await a trigger event and remains in sleep or low power consumption mode.

If a trigger event is detected, then at step 106, the IWP changes to an active state (from a sleep or low-battery consumption mode) to initiate or start a message exchange session with the mobile device, the back-end system, or any nearby device. At step 108, the IWP determines if the trigger event is an incoming message. If so, then at step 110 the message is received and processed, with any follow-up action needed. One the message is processed, the IWP returns to low power mode or sleep mode the process returns to step 104 awaiting a new trigger event. If at step 108, it is determined that the trigger event is not an incoming message or event, then the process moves to step 112. The IWP generates the message, which can be an event or information or an alert, and at step 114 transmits the information. If all transmissions associated with the outgoing information are complete, the IWP returns to step 104 and low power or sleep mode.

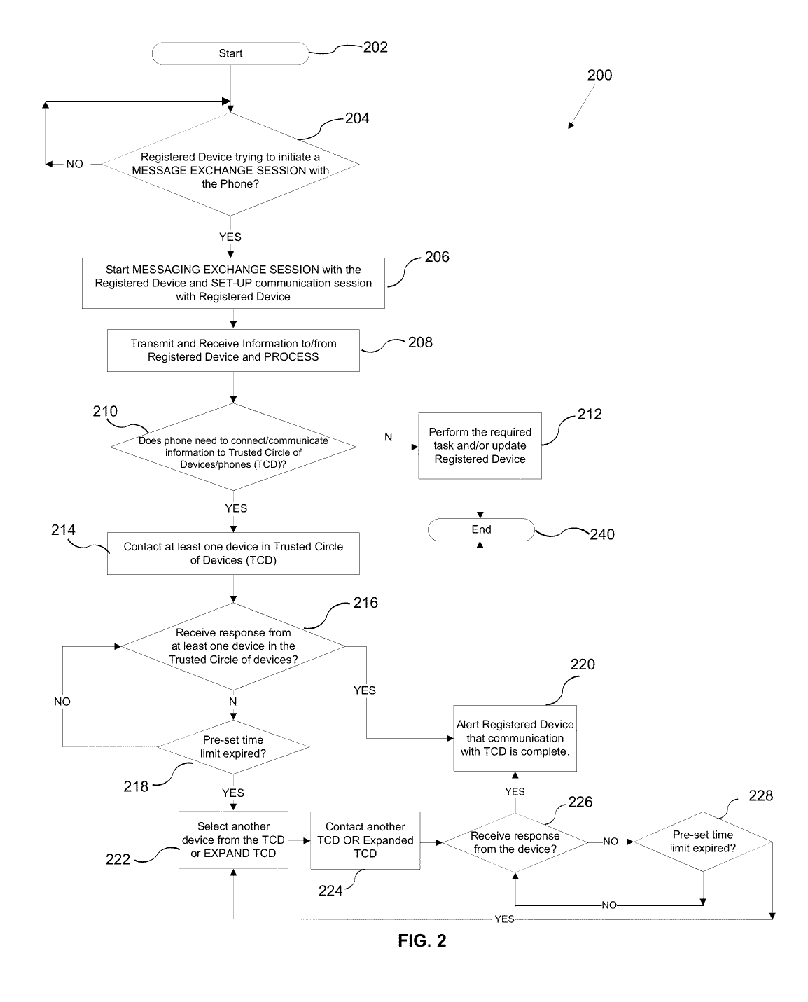

Referring now to FIG. 2, in accordance with various aspects of the invention, a flow process 200 is shown for communication to/from the mobile device linked to the IWP. The process starts at step 202 and at step 204 the mobile device determines if there is a need to initiate a message exchange session (MES), because the IWP is trying to send information to the mobile device or vise-versa. If a session is not initiated, then the process returns to step 202.

If a MES is needed, then the process moves to step 206 to start the MES session with the IWP. The process moves to step 208 where the information is transmitted or received and processed. At step 210, the mobile device, with the software therein, determines if processing of the information resulted in a situation that requires contacting a person in the PPN or the TCD. If not, then the process moves to step 212 and performs the required task or action and, if needed, updates the IWP and the MES ends at step 240. If at step 210, the mobile device has to contact a person in the TCD (or the PPN), then the process moves to step 214 and a message or information is sent to at least one person in the TCD (or the PPN).

At step 216, the process, which is running on the mobile device, determines if a response is received from at least one person in the TCD. If not, the process waits at step 218 until a pre-determined time limit expires and then moves to step 222 to select another person from the list of TCD and the alternative person or persons from the list of TCD or PPN are contacted at step 224. If a response is received at step 216 from a person in the TCD, then the process moves to step 220 to alert the IWP that a message has been communicated to at least one person in the TCD and the information received during the MES is sent to at least one person in the TCD.

If contact is initiated with alternative persons at step 224, the process moves to steps 226 and 228 and as noted above awaits confirmation that some in the TCD has been reached. This continues until at least one person in the TCD is reached or attempts have been made to reach all individuals or person in the TCD/PPN. If no individual was reached, then the mobile device can attempt to contact parties outside the TCD depending on the parameters defined by the use of the IWP and information stored about the use in the back-end system.

Optionally, various third party systems may be contacted simultaneously with an attempt to contact a person in a TCD, or subsequent to failing to contact anyone in the TCD. For instance, the third party system may include emergency health services, law enforcement, fire station, local caregivers, or any other type of third party system. This may include a call to 9-1-1, or any other emergency services. Whether a third party is contacted or not may depend on how the user sets up the TCD/PPN ahead of time. For instance, a user may indicate whether the user wishes a third party to be contacted at all in the event that no one from a TCD/PPN is reachable, or whether to contact the third party concurrently with reaching out to the TCD/PPN. The user may also indicate ahead of time which third party (or parties) are to be contacted. For instance, if the user knows the user is prone to health issues, the user may have emergency medical services be contacted. If the user knows the user lives in a high-crime neighborhood, the user may have law enforcement be contacted.

A user may establish a user's TCD and/or PPN ahead of time. In some instances, the user may input information about the user's TCD/PPN using an external device, such as a mobile device, computer, or any other type of device. The user may enter information, such as contact information for members of the user's TCD/PPN (e.g., phone number, email, etc.), how each member prefers to be contacted, whether the members have their own IWPs, any limits to when various members may be contacted (e.g., some members may be contacted at any time, or some members may be only contacted on certain days of the week or times of day), any geographic limits to when various members may be contacted (e.g., some members may only be contacted when in a particular area, or outside a particular area, or may only be contacted within a certain geographic distance from the user), any preference or ordering of the members to contact (e.g., first contact member A, and if member A does not respond, contact member B, etc.), or different scenarios where different contacts or orders of contacts may be provided (e.g., in the case of a minor emergency, preferred order of contacts may be A, B, C, D; in the event of major emergency, preferred order of contacts may be B, C, E, A, F). Factors such as timing, geography (e.g., member location, user location, or a combination thereof), indicators by members (e.g., some members may indicate that they are currently out of contact, or are only to be contacted for certain types of outgoing messages), type of contact, and/or user preference may play a factor into order in which members are contacted, or which members are contacted. Such circumstantial factors may also play a role in determining which third parties, if any, are contacted, and at what point in time. Thus, the user may determine the outgoing contact rules. Input or indicators may members may also affect the outcome of who is contacted.

A user may thus use the IWP send outgoing messages to the user's TCD/PPN and/or third parties. The content of the message may be simple (e.g., an indication of a major emergency or a minor emergency) and may be sent to the contacts in accordance with one or more outgoing contact rules. The user may enter, and/or update or alter the contact rules and/or contacts. The contacts may receive the message at an IWP of the contact, or another device, such as a mobile device, telephone or computer.

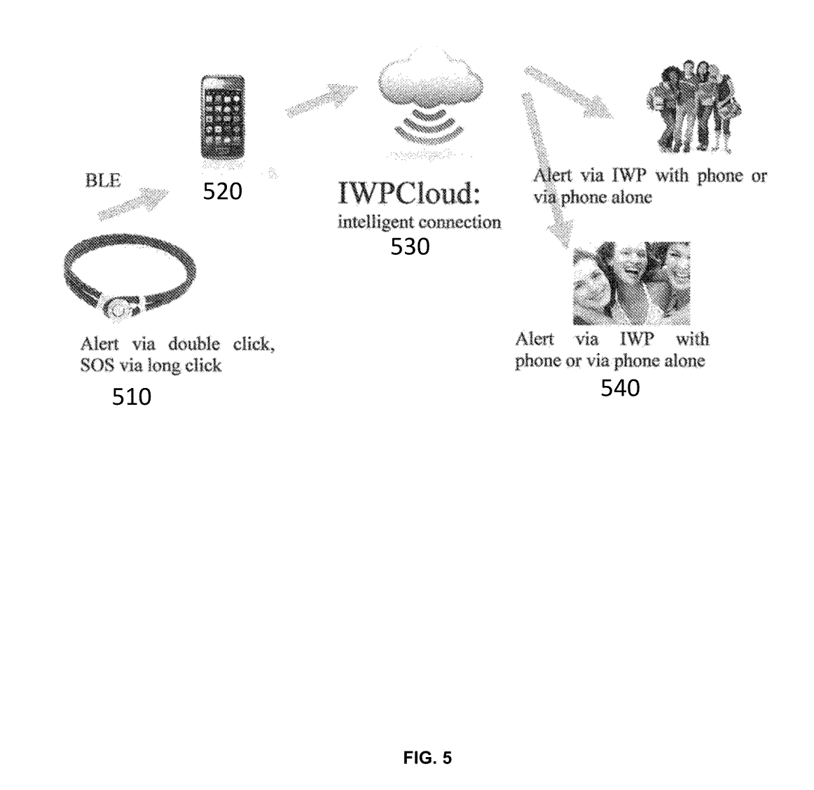

FIG. 5 provides an example of communications that may occur using an IWP. An individual may be wearing or carrying an IWP. The individual may send an outgoing message 510. The outgoing message may be differentiated based upon an input from a user. For instance, the outgoing message may be an alert (e.g., minor emergency) or an SOS (e.g., major emergency). For instance, the alert may go out if the user provides a double click or tap. The SOS may go out if the user provides a single long click or tap.

The IWP may communicate with an external device, such as a mobile device 520. The IWP may communicate with the external device via BLE or any other type of direct communications, as described elsewhere herein. The external device may or may not interpret the input from the user and differentiate the type of message. Alternatively, the IWP may perform the interpretation step. The IWP or the external device may determine which members or parties should be contacted. For instance, the external device may have an application or software that may include the individual's members of a TCD or PPN. The external device may make an attempt to contact a first member of the individual's TCD/PPN. If the first member is unavailable or does not acknowledge the alert or SOS, the external device may make an attempt to contact the second member, and so forth. A single member may be contacted at a time and the TCD/PPN members may be contacted sequentially. Alternatively, two or more members may be contacted simultaneously.

The external device may communicate over a network 530. The network may include any type of network as described elsewhere herein. For instance, the network may be an IWP cloud, which may provide intelligent connection.

As previously mentioned, one or more individuals may be contacted 540. The individuals may receive the alert or SOS. Different members may be designated to receive different types of outgoing messages. For instance, a first pool of individuals may receive a first type of outgoing message while a second pool of individuals may receive a second type of outgoing message. The first and second pools may or may not overlap members. The individuals may receive the alerts via an IWP or via an external device (e.g., mobile device, such as a smartphone). The individual may receive alerts via IWP and external device if the individual has both, or via the IWP alone, or via the external device alone.

The user may optionally receive incoming message with aid of the IWP. The content of the incoming message may also be simple (e.g., an indication of a major emergency or a minor emergency). The content may be differentiated depending on a feedback to the user (e.g., tactile feedback, audio feedback, visual feedback, or any combination). For instance, a major emergency may be communicated to the user as two pulses while a minor emergency may be communicated to the user as a single pulse. The user may receive the incoming message with aid of an external device, such as a mobile device. For instance, the user may receive a phone call, text message, chat request, or alert on the user's mobile device. The user may be a member of a TCD or PPN of a second user. The second user may send the message being received by the user. The user may acknowledge receipt of the incoming message. This may optionally prevent the second user's IWP from contacting additional individuals that are members of the second user's TCD or PPN.

As previously described, the IWP may come in various form factors. The IWP may include a substrate and a registered device. The registered device may include electronics and/or be capable of two-way communications. The substrate may or may not include electronics. The substrate may be decorative. FIGS. 4C-4F provide examples of various IWP form factors. For instance, FIG. 4C shows a pendant having a registered device 300. FIG. 4D shows an example of a bracelet with a registered device 300. FIG. 4E shows another example of a bracelet/bangle having a registered device 300. FIG. 4F shows an example of a bracelet/cuff having a registered device 300. The registered device may be on an outer surface or inner surface of the IWP. The registered device may fit into an indentation or a cavity of the IWP.

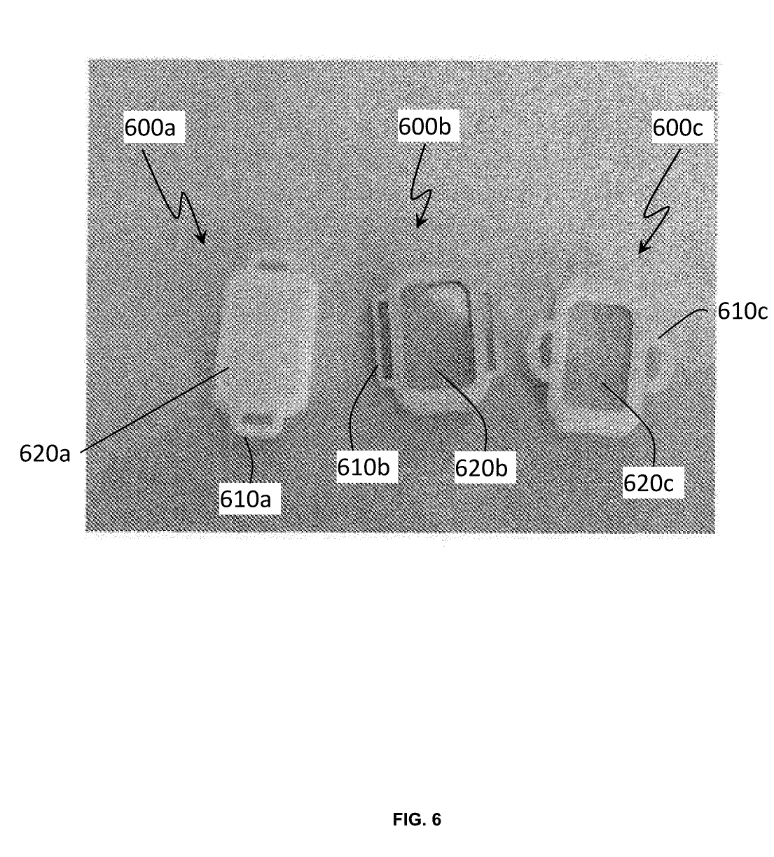

FIG. 6 shows various housings 600a-c for the IWP. The housing may have various shapes or configurations. Different housings (e.g., optionally having different shapes and/or sizes) may be configured to accommodate the same registered device, or the same size and/or shape of the registered device. The housings may have connection points 610a-610c at one or more portion of the housing. The connection points may include loops, openings, protrusions, indentations, magnets, grooves, locking mechanisms, or any other mechanism that may permit the housing to be attached to the rest of the substrate. The connection points may allow the housing to be removably attached to the rest of the housing. The connection points may allow a housing to be connected with the rest of a substrate. For instance, the rest of the substrate may include a strap, band, chains, mesh, netting, beads, links, or any other configuration.

The housings may include a support surface 620a-620c. The support surface of the housing may allow a face of the registered device to rest against the housing. The support surface may be part of an indentation or cavity of the housing configured to accept the registered device. The support surface may be opaque, translucent, or transparent. For instance, the support housing may be clear to allow the registered device to be viewable from an opposing side of the support surface. The support surface may form a window that may allow the registered device to be seen. Alternatively, the support surface may partially or completely obscure the registered device.

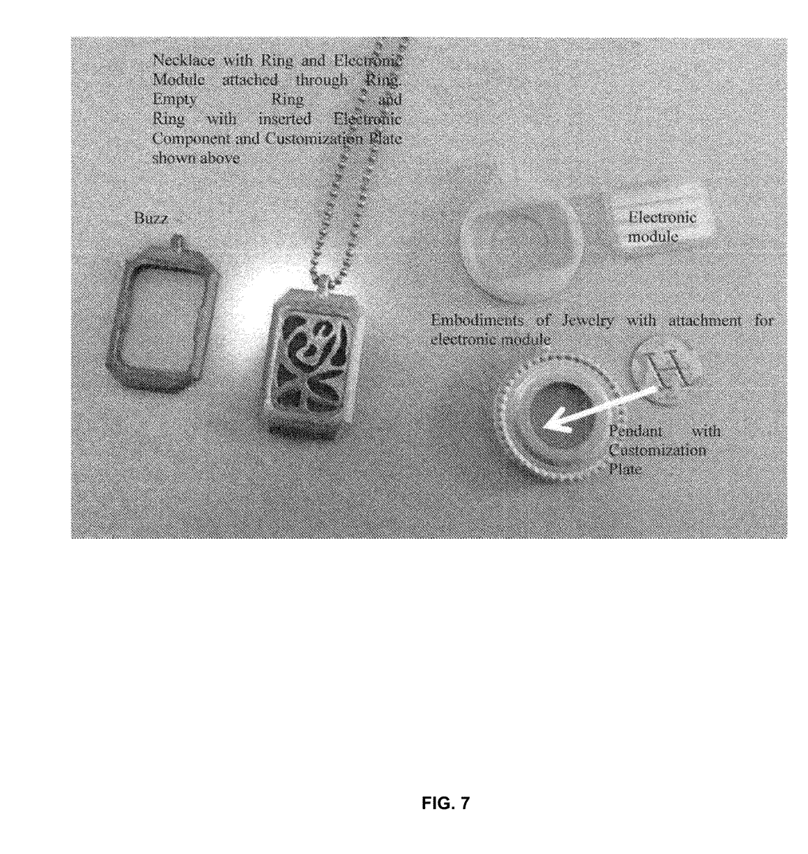

FIG. 7 shows various implementations of the IWP. As previously described, a registered device (e.g., electronic module) may be removed and attached to various jewelry formats. For instance, the electronic module may fit into both a rectangular pendant and a circular pendant as illustrated. The jewelry may be customized using the registered device. For instance, different registered devices may have different appearances, which may be visible on the jewelry. Similarly, different registered devices may have different functions. The jewelry may be further customizable and include decorative components that may be swapped in and out. For instance, a decorative plate having a personalized symbol (e.g., letter, images, shapes) or appearance may be swapped in and out. Rings, jewels, or other decorative features may be swapped in and out.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order which is logically possible.

In accordance with the teaching of the invention and certain embodiments, a program or code may be noted as running on a computing device. A computing device is an article of manufacture. Examples of an article of manufacture include: a server, a mainframe computer, a mobile device, mobile telephone, a multimedia-enabled smartphone, a tablet computer, a personal digital assistant, a personal computer, a laptop, a set-top box, an MP3 player, an email enabled device, a web enabled device, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods. The article of manufacture (e.g., computing device) includes a non-transitory computer readable medium having a series of instructions, such as computer readable program steps encoded therein. In certain embodiments, the non-transitory computer readable medium includes one or more data repositories.

By way of illustration and not limitation, the computing device can include: an input/output means, such as a keyboard, a mouse, a stylus, touch screen, a camera, a scanner, or a printer; a processor; a non-transitory computer readable medium including at least one instruction/task or a series of instructions, such as computer readable program with steps encoded therein.

The non-transitory computer readable medium includes corresponding computer readable program code and may include one or more data repositories. The processors access the computer readable program code encoded on the corresponding non-transitory computer readable mediums and execute one or more corresponding instructions. Other hardware and software components and structures are also contemplated.

In accordance with various aspects of the invention and in certain embodiments, a data repository is referenced. The data repositories comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, etc.

In accordance with various aspects of the invention and in certain embodiments, the data repository is structured by a database model, such as a relational model, a hierarchical model, a network model, an entity-relationship model, an object-oriented model, a combination thereof, or the like. For example, in certain embodiments, the data repository is structured in a relational model that stores data regarding a computer-aided design.

In accordance with various aspects of the invention and in certain embodiments and in accordance with any aspect of the invention, computer readable program code is encoded in a non-transitory computer readable medium of the computing device. The processor, in turn, executes the computer readable program code to create or amend an existing computer-aided design using a tool. In other embodiments, the creation or amendment of the computer-aided design is implemented as a web-based software application in which portions of the data related to the computer-aided design or the tool or the computer readable program code are received or transmitted to a computing device of a host.

In certain embodiments based on the various aspects of the invention, reference is made to communication between two electronic devices or components. The communication fabric may include any means for communication and, includes, for example: wired communication on a local bus, communication throughout a computer device, the Internet, an intranet, an extranet, a storage area network (SAN), a wide area network (WAN), a local area network (LAN), a virtual private network, a satellite communications network an interactive television network, any combination of the foregoing, and the like. In certain embodiments, the communication fabric contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabric utilize any of a variety of communication protocols, such as Transmission Control Protocol/Internet Protocol (TCP/IP), for example. In certain embodiments, the communication fabric includes one or more switches.

In accordance with various aspects of the invention and in certain embodiments, the processor accesses corresponding Application Program Interfaces (APIs) encoded on the corresponding non-transitory computer readable medium and execute instructions to electronically communicate with computing device during a computer-aided session, for example. Similarly, the processor accesses the computer readable program code, encoded on the non-transitory computer readable medium, and executes an instruction to electronically communicate with the computing device via the respective communication fabric. In certain embodiments, the computing device 110 provides access to the computing devices to execute the computer readable program code via Software as a Service (SaaS).

In accordance with various aspects of the invention and in certain embodiments, the system includes a hardware-based module (e.g., a digital signal processor (DSP), a field programmable gate array (FPGA)) and/or a software-based module (e.g., a module of computer code, a set of processor-readable instructions that are executed at a processor). In some embodiments, one or more of the functions associated with the system is performed, for example, by different modules and/or combined into one or more modules locally executable on one or more computing devices.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. Rather, the scope and spirit of invention is embodied by the description herein and the Appendix and related to the claim.

What is claimed is:

1. An intelligent wearable device comprising:
a housing; and
an event indication module secured within the housing configured to receive a tactile input from a user corresponding to an outgoing communication type from a plurality of available outgoing communication types, and generate a signal based on the tactile input to be sent to an external device, wherein the signal permits discernment of the outgoing communication type from the plurality of outgoing communication types.

2. The device of claim 1, wherein the plurality of outgoing communication types includes an indication of a minor emergency and an indication of a major emergency.

3. The device of claim 1, wherein the tactile input from the user corresponds to the outgoing communication type based on a number of touches by a user or the length of one or more touches by the user.

4. The device of claim 1, wherein the event indication module comprises:
a power source;
a control module electrically connected to the power source;
a low energy communication module electrically connected to the power source and controlled by the control module; and
an antenna electrically connected to the communication module, wherein the antenna is configured to transmit the signal to the external device.

5. The device of claim 4, wherein the event indication module further comprises:
a button, wherein the button is used to receive the tactile input from the user and cause the antenna to transmit the signal to an external device.

6. The device of claim 1, wherein the housing can be physically attached to a plurality of jewelry items.

7. The device of claim 1, wherein the low energy communication module uses at least one protocol selected from the group of protocols including BLE protocol and RF protocol to transmit the signal to the external device.

8. The device of claim 1, wherein the external device is configured to further transmit an outgoing communication to a device of a predetermined member of the user's contact list, wherein the predetermined member is able to discern the outgoing communication type from the plurality of outgoing communication types.

9. The device of claim 1, wherein the device is configured to receive a signal from the external device and generate a detectable response discernible by the user.

10. The device of claim 9, wherein the detectable response is a vibration, sound, or visual effect.

11. The device of claim 9, wherein the detectable response is configured to permit the user to discern an incoming communication type from a plurality of available incoming communication types.

12. A method for communication to/from a wearable apparatus, the method comprising:
providing a housing;
removing a first event indication module initially secured within the housing, wherein the first event indication module is configured to send or receive communications with an external device in accordance with a first set of specifications; and
securing a second event indication module within the housing, wherein the second event indication module is configured to send or receive communications with an external device in accordance with a second set of specifications different from the first set of specifications.

13. The method of claim 12, wherein the housing comprises a cavity into which the first event indication module and the second event indication module fit.

14. The method of claim 12, wherein the housing is integrated into jewelry.

15. The method of claim 14, wherein the first event indication module has a first exposed surface when the first event indication module is secured within the housing, and wherein the second event indication module has a second exposed surface when the second event indication module is secured within the housing.

16. The method of claim 15, wherein the first exposed surface and the second exposed surface are on a side facing the user when the jewelry is worn by the user.

17. The method of claim 15, wherein the first event indication module or the second event indication module is configured to receive a tactile input by the user that initiates outgoing communications.

18. The method of claim 12, wherein the first set of specifications and the second set of specifications differ in type of outgoing communications to the external device.

19. The method of claim 12, wherein the first set of specifications and the second set of specifications differ in user inputs to the first event indication module and the second event indication module, respectively, corresponding to outgoing communications.

20. The method of claim 12, wherein the first set of specifications and the second set of specifications differ in detectable responses generated by the first event indication module and the second event indication module, respectively, corresponding to incoming communications.
